(19) United States
(12) Patent Application Publication
(10) Pub. No.: US 2017/0195115 A1
(43) Pub. Date: Jul. 6, 2017

(54) PLAINTEXT ENCRYPTION METHOD

(71) Applicant: YINNON KADISHSON YANAY, TEL-AVIV (IL)

(72) Inventor: YINNON KADISHSON YANAY, TEL-AVIV (IL)

(21) Appl. No.: 15/326,486

(22) PCT Filed: Feb. 22, 2015
(86) PCT No.: PCT/IL2015/050198

§ 371 Date: Jan. 15, 2017

(30) Foreign Application Priority Data
Jul. 20, 2014 (IL) 233720

(51) Int. Cl. H04L 9/06; H04N 1/44; G09C 1/10

(52) U.S. Cl. CPC H04L 9/065; G09C 1/10; H04N 1/4486

(57) ABSTRACT

A plaintext encryption method comprising the steps of converting plaintext (20) into information (18) capable of representing visual information! and producing at least two random codes (14A, 14B, 14C), wherein combination thereof equals the information (18) capable of representing visual information, thereby encrypting the plaintext (20) to the random codes (14A, 14B, 14C).

### TECHNICAL FIELD

The present invention relates to the field of cryptography. More particularly, the invention relates to a method for encrypting plaintext through visual encryption.

### BACKGROUND ART

“In cryptography, plaintext is information a sender wishes to transmit to a receiver. Cleartext is often used as a synonym. Plaintext has reference to the operation of cryptographic algorithms, usually encryption algorithms, and is the input upon which they operate. Cleartext, by contrast, refers to data that is transmitted or stored unencrypted (that is, ‘in the clear’).

Before the computer era, plaintext most commonly meant message text in the language of the communicating parties. Since computers became commonly available, the definition has expanded to include: messages (for example, email messages), document content (for example, word processor files), audio files, ATM and credit card information, sensor data, any other data that a person wishes to keep private

“(from http://en.wikipedia.org/wiki/Plaintext)

“Encryption does not of itself prevent interception, but denies the message content to the interceptor. In an encryption scheme, the message or information, referred to as plaintext, is encrypted using an encryption algorithm, generating ciphertext that can only be read if decrypted. For technical reasons, an encryption scheme usually uses a pseudo-random encryption key generated by an algorithm. It is in principle possible to decrypt the message without possessing the key, but, for a well-designed encryption scheme, large computational resources and skill are required. An authorised recipient can easily decrypt the message with the key, provided by the originator to recipients but not to unauthorised interceptors

“(from http://en.wikipedia.org/wiki/Encryption)

“A key is a piece of information (a parameter) that determines the functional output of a cryptographic algorithm or cipher. Without a key, the algorithm would produce no useful result. In encryption, a key specifies the particular transformation of plaintext into ciphertext, or vice versa during decryption. Keys are also used in other cryptographic algorithms, such as digital signature schemes and message authentication codes.

To prevent a key from being guessed, keys need to be generated truly randomly and contain sufficient entropy. The problem of how to safely generate truly random keys is difficult, and has been addressed in many ways by various cryptographic systems.

“from (http://en.wikipedia.org/wiki/Key_(cryptography))

However, the key only is random, whereas the ciphertext, produced by the key, is not random.

It is an object of the present invention to provide an method for encrypting plaintext, in which the ciphertext as well is random.

It is an object of the present invention to provide a solution to the above-mentioned and other problems of the prior art.

Other objects and advantages of the invention will become apparent as the description proceeds.

### SUMMARY OF THE INVENTION

A plaintext encryption method comprising the steps of:
converting plaintext (20) into information (18) capable of representing visual information; and
producing at least two random codes (14A, 14B, 14C), wherein combination thereof equals the information (18) capable of representing visual information,

thereby encrypting the plaintext (20) to the random codes (14A, 14B, 14C).

The method may further comprise the step of:
encrypting each of the at least two random codes (14A, 14B) to ciphertext (16A, 16B).

The step of encrypting each of the at least two random codes (14A, 14B) to ciphertext (16A, 16B), may comprise applying an R.S.A algorithm.

The step of producing the at least two random codes (14A, 14B) may comprise visual encrypting.

The combination of the at least two random codes (14A, 14B) may comprise the XOR function.

The information (18) capable of representing visual information may comprise a series of binary codes, each representing an on or an off, for representing a black and white pixel of visual information of an image.

The information (18) capable of representing visual information may comprise a series of non-binary codes, each representing a colored pixel of visual information of an image.

The step of converting the plaintext (20) into the information (18) capable of representing visual information, may comprise the steps of:
converting each character of the plaintext (20) into a non-random code (22) through a known conversion table, such as ASCII; and
converting the non-random code (22) into information of a series of pixels.

The step of converting the plaintext (20) into the information (18) capable of representing visual information, may comprise the steps of:
optically scanning the plaintext (20); and
converting the scanning into information of a series of pixels.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a block diagram of the encrypting and decrypting steps, according to one embodiment of the present invention.

FIG. 2 is an example applying the block diagram of the encrypting and decrypting steps of FIG. 1.

FIG. 3 shows another example of the second step of FIG. 1, for producing three visual codes.

FIG. 4 is an example applying the block diagram of the encrypting and decrypting steps of FIG. 1 according to another example.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

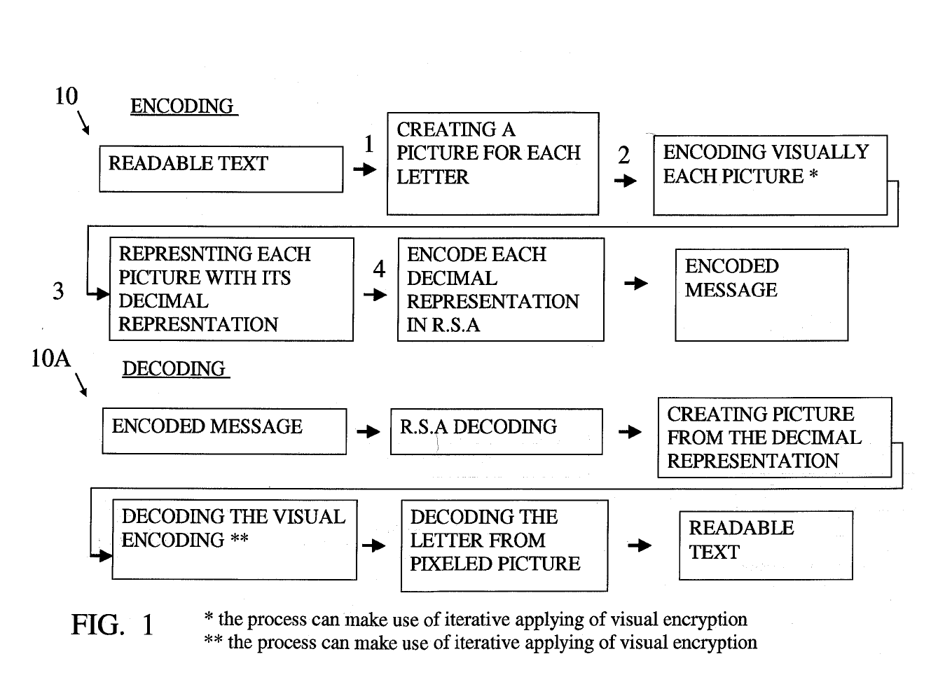

FIG. 1 is a block diagram of the encrypting and decrypting steps, according to one embodiment of the present invention.

According to the encrypting steps of FIG. 1, the present invention application encrypts plaintext through visual encryption.

At the first step, enumerated “1” in FIG. 1 of the encrypting method enumerated 10, plaintext is converted to information capable of representing visual information.

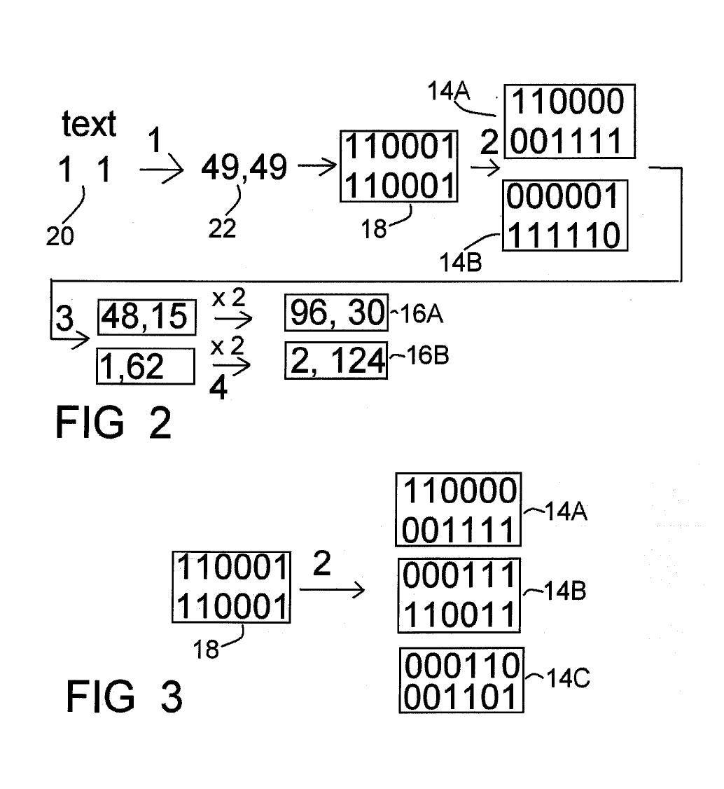

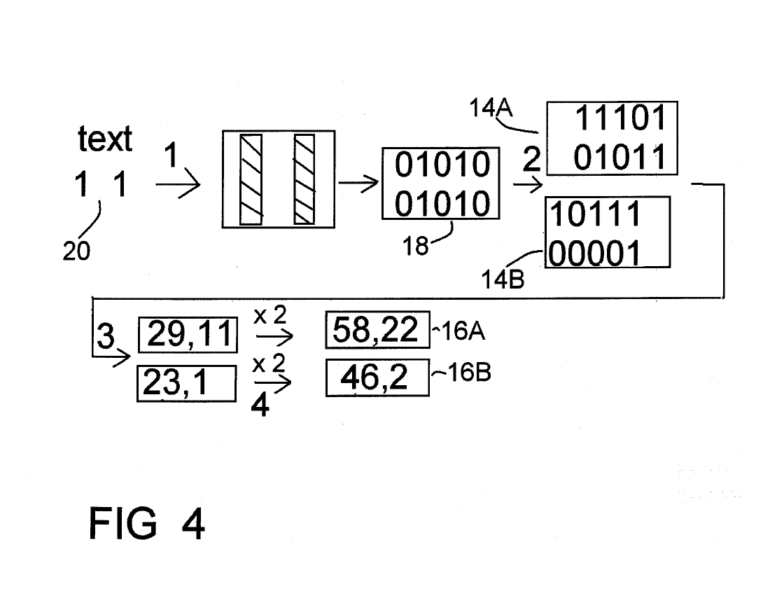

Various approaches may be applied for converting the plaintext to the information capable of representing visual information. FIGS. 2 and 4 describe two different approaches.

FIG. 2 is an example applying the block diagram of the encrypting and decrypting steps of FIG. 1.

According to one example, each character of the plaintext 20 may be converted to a visual binary display of the ASCII code 22 thereof, wherein the ASCII code is an example of a known conversion table. For example, the plaintext “11” enumerated 20, for which the ASCII codes in the ASCII table (http://www.asciitable.com/) are 49 and 49, may be converted at the first step, enumerated “1” in FIG. 2, to the visual binary display of 110001 (binary code of 49) and 110001 (binary code of 49), thus being 110001′110001 (the apostrophe is added for reading convenience only), enumerated 18, which is the combination thereof.

This 110001′110001 code information enumerated 18 is capable of representing visual information indicated by the first step of FIG. 1, since each “1” may be represented by a black pixel and each “0” may be represented by a white pixel. According to another embodiment, each pixel may be a colored pixel, thus having a broad range.

At the second step, enumerated “2” in FIG. 1, the information 18 capable of representing visual information (herein “visual information”) is encoded by visual cryptography.

“Visual cryptography is a cryptographic technique which allows visual information (pictures, text, etc.) to be encrypted in such a way that decryption becomes a mechanical operation that does not require a computer.

One of the best-known techniques has been credited to Moni Naor and Adi Shamir, who developed it in 1994. They demonstrated a visual secret sharing scheme, where an image was broken up into n shares so that only someone with all n shares could decrypt the image, while any n−1 shares revealed no information about the original image. Each share was printed on a separate transparency, and decryption was performed by overlaying the shares. When all n shares were overlaid, the original image would appear.

Using a similar idea, transparencies can be used to implement a one-time pad encryption, where one transparency is a shared random pad, and another transparency acts as the ciphertext.

In this example, the image has been split into two component images. Each component image has a pair of pixels for every pixel in the original image. These pixel pairs are shaded black or white according to the following rule: if the original image pixel was black, the pixel pairs in the component images must be complimentary; randomly shade one black-white, and the other white-black. When these complementary pairs are overlapped, they will appear dark gray. On the other hand, if the original image pixel was white, the pixel pairs in the component images must match: both black-white or both white-black. When these matching pairs are overlapped, they will appear light gray.

So, when the two component images are superimposed, the original image appears. However, considered by itself, a component image reveals no information about the original image; it is indistinguishable from a random pattern of black-white/white-black pairs. Moreover, if you have one component image, you can use the shading rules above to produce a counterfeit component image that combines with it to produce any image at all.

There is a simple algorithm for binary (black and white) visual cryptography that makes 2 images of one main image, the algorithm is explained as follows: let's take first image a completely random image in size of main image, and the second one will be as same as the first one, but when a pixel of main image the second one will change value to exclusive or (XOR) of the first one. Now we have two images, that lonely they don't make any sense, but when XOR these two pictures, the main picture will be shown.

“(from http://en.wikipedia.org/wiki/Visual cryptography)

The above article includes a “demonstration of visual cryptography. When two same-sized images of apparently random black-and-white pixels are superimposed, the Wikipedia logo appears.”

The following examples will assume the XOR algorithm as a typical visual cryptography technique.

According to the example of the second step, enumerated “2” in FIG. 2, of producing two visual codes by applying the XOR algorithm, the first visual code 14A may be randomly determined to be 110000′001111, and the second visual code 14B may be determined to be 000001′111110, since 110000′001111 XOR 000001′111110 equals the visual information 110001′110001 enumerated 18.

At the third and fourth steps, enumerated “3” and “4” in FIG. 1, each of the visual codes is encoded separately.

According to the example of the third and fourth steps, enumerated “3” and “4” in FIG. 2, the 110000′001111 code is converted to decimal representation, thus to 48 (for the 110000 portion) and 15 (for the 001111 portion); and each of them is encrypted to a ciphertext, namely 16A and 16B. Thus, random code 14A is encrypted to a ciphertext 16A, and random code 14B is encrypted to a ciphtext 16B.

FIG. 2 depicts an exemplary multiply-by-2 encryption to 96 (for the 48 portion) and 30 (for the 15 portion), constituting together ciphertext 16B; and the 000001′111110 code is converted to decimal representation of 1 (for the 000001 portion) and 62 (for the 111110 portion), and these are encrypted by a multiply-by-2 encryption to 2 (for the 1 portion) and 124 (for the 62 portion), constituting together ciphertext 16B.

The multiply-by-2 is of course only a simplified example for an encryption algorithm. According to a preferred embodiment, the R.S.A algorithm may be selected. RSA stands for Ron Rivest, Adi Shamir and Leonard Adleman, who first publicly described the algorithm in 1977.

At the second step, enumerated “2” in FIG. 1, the information capable of representing visual information, encoded by visual cryptography, may produce a larger number of random codes, than the example of FIG. 2.

FIG. 3 shows another example of the second step, enumerated “2”, of producing more than two visual code, being three visual codes in the example.

The first visual code 14A may be randomly determined to be 110000′001111 (as in FIG. 2); the second visual code 14B may be randomly determined to be 000111′110011; and the third visual code 14C may be determined to be 000110′001101, since 110000′001111 XOR 000111′110011 XOR 000110′001101 equals the visual information 110001′110001 enumerated 18.

FIG. 4 is an example applying the block diagram of the encrypting and decrypting steps of FIG. 1 according to another example.

According to one embodiment, the characters of the plaintext may be converted to the information capable of representing visual information, by applying optical means, thus the information capable of representing visual information is in fact visual information.

For example, the plaintext “ ” may be converted to the image thereof, such that (if neglecting a portion) it may include two spaced vertical lines (shown in box enumerated 12), which may be represented by 01010′01010 via optical scanning. The next steps depicted in FIG. 4 are identical to those of FIG. 2.

The steps of the decrypting method enumerated 10A in FIG. 1, substantially are the reverse steps of the encrypting method 10A of FIG. 1.

In the figures and/or description herein, the following reference numerals (Reference Signs List) have been mentioned:
numeral 10 denotes an encrypting method, according to one embodiment of the present invention;
numeral 10A denotes a decrypting method, according to one embodiment of the present invention;
numeral 12 denotes two spaced vertical lines;
numerals 14A, 14B, and 14C denote random codes, being an encryption of the plaintext;
numerals 16A and 16B denote ciphertexts being an encryption of the plaintext;
numeral 18 denotes information capable of representing visual information, for example of an array of black and white pixels;
numeral 20 denotes plaintext for being encrypted;
numeral 22 dentoes a code produced from the plaintext, the code not yet encrypted.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A plaintext encryption method comprising the steps of:
converting plaintext (20) into information (18) capable of representing visual information; and
producing at least two random codes (14A, 14B, 14C), wherein combination thereof equals said information (18) capable of representing visual information,
thereby encrypting said plaintext (20) to said random codes (14A, 14B, 14C).

2. A plaintext encryption method according to claim 1, further comprising the step of:
encrypting each of said at least two random codes (14A, 14B) to ciphertext (16A, 16B).

3. A plaintext encryption method according to claim 2, wherein said step of encrypting each of said at least two random codes (14A, 14B) to ciphertext (16A, 16B), comprises applying an R.S.A algorithm.

4. A plaintext encryption method according to claim 1, wherein said step of producing said at least two random codes (14A, 14B) comprises visual encrypting.

5. A plaintext encryption method according to claim 1, wherein a function of said combination of said at least two random codes (14A, 14B) comprises a XOR function.

6. A plaintext encryption method according to claim 1, wherein said information (18) capable of representing visual information comprises a series of binary codes, each representing an on or an off, for representing a black and white pixel of visual information of an image.

7. A plaintext encryption method according to claim 1, wherein said information (18) capable of representing visual information comprises a series of non-binary codes, each representing a colored pixel of visual information of an image.

8. A plaintext encryption method according to claim 1, wherein said step of converting said plaintext (20) into said information (18) capable of representing visual information, comprises the steps of:
converting each character of said plaintext (20) into a non-random code (22) through a known conversion table; and
converting said non-random code (22) into information of a series of pixels.

9. A plaintext encryption method according to claim 1, wherein said step of converting said plaintext (20) into said information (18) capable of representing visual information, comprises the steps of:
optically scanning said plaintext (20); and
converting the scanning into information of a series of pixels.
